(19) United States
(12) Patent Application Publication
(10) Pub. No.: US 2013/0124116 A1
(43) Pub. Date: May 16, 2013

(54) SYSTEMS AND METHODS FOR PREDICTING THE LIFETIME OF AN ELECTROMECHANICAL DEVICE

(71) Applicants: Yan Du, Fremont, CA (US); Kostadin D. Djordjev, San Jose, CA (US); Denis H. Endisch, Cupertino, CA (US); Wilhelmus A. de Groot, Palo Alto, CA (US); Daniel Felnhofer, San Jose, CA (US)

(72) Inventors: Yan Du, Fremont, CA (US); Kostadin D. Djordjev, San Jose, CA (US); Denis H. Endisch, Cupertino, CA (US); Wilhelmus A. de Groot, Palo Alto, CA (US); Daniel Felnhofer, San Jose, CA (US)

(73) Assignee: QUALCOMM MEMS Technologies, Inc., San Diego, CA (US)

(21) Appl. No.: 13/296,988

(22) Filed: Nov. 15, 2011

(51) Int. Cl. G06F 19/00

(52) U.S. Cl. 702/58

(57) ABSTRACT

This disclosure provides systems, methods and apparatus, including computer programs encoded on computer storage media, for estimating the lifetime or remaining lifetime of an electromechanical systems (EMS) device. In one aspect, a parameter of the device, such as a release or actuation voltage, is measured. The parameter measurement is used in conjunction with a model of the aging of the device according to the measured parameter to determine an estimated remaining lifetime of the device.

### TECHNICAL FIELD

This disclosure relates to electromechanical devices, and more particularly to systems and methods for determining an estimated lifetime of an electromechanical device.

### DESCRIPTION OF THE RELATED TECHNOLOGY

Electromechanical systems (EMS) include devices having electrical and mechanical elements, actuators, transducers, sensors, optical components (including mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

Manufactured electromechanical displays vary in quality and reliability. Electromechanical display companies may wish to screen electromechanical display panels, either during manufacturing or subsequent testing, to determine or predict the panel's lifetime without taking a substantial amount of time or life due to the testing. Such testing and screening could include accelerated testing or include burn-in testing.

### SUMMARY

The systems, methods and devices of the disclosure each have several innovative aspects, no single one of which is solely responsible for the desirable attributes disclosed herein.

One innovative aspect of the subject matter described in this disclosure can be implemented in a device including circuitry configured to apply a driving voltage across a electromechanical systems (EMS) device, and a processor, where the processor is configured to measure a release voltage of the EMS device at more than one point in time, and estimate a remaining lifetime of the EMS device based at least in part on the measured release voltages.

The processor can be configured to estimate the lifetime based at least in part on a model of the release voltage of the device as a function of time. The processor can be further configured to initiate a calibration operation on the EMS device. The processor can be further configured to determine whether the estimated remaining lifetime of the EMS device is below a threshold, and assign a quality level to the device in response to the determination of whether the estimated remaining lifetime of the EMS device is below a threshold. The processor can be further configured to screen the device for failure due to stiction based at least in part on the estimated remaining lifetime of the device.

Another innovative aspect of the subject matter described in this disclosure can be implemented in a method of testing an electromechanical systems (EMS) device, the method including measuring a release voltage of an EMS device at more than one point in time to obtain a plurality of measured release voltages, and estimating a remaining lifetime of the EMS device based at least in part on the measured release voltages.

The method also can include determining whether the estimated remaining lifetime of the EMS device is below a threshold. The method also can include performing a recalibration operation in response to a determination that the estimated remaining lifetime of the EMS device is below the threshold.

Another innovative aspect of the subject matter described in this disclosure can be implemented in a computer readable medium, including instructions, which, when executed cause the computer to perform a method of testing an electromechanical systems (EMS) device, the method including measuring a release voltage of an EMS device at more than one point in time to obtain a plurality of measured release voltages, and estimating a remaining lifetime of the EMS device based at least in part on the measured release voltages.

Another innovative aspect of the subject matter described in this disclosure can be implemented in a device, including circuitry configured to apply a driving voltage across a electromechanical systems device (EMS), and means for estimating a remaining lifetime of the EMS device based at least in part on measured release voltages of the EMS device. The estimating means can include a processor, the processor configured to measure a release voltage of the EMS device at more than one point in time, and estimate a remaining lifetime of the EMS device based at least in part on the measured release voltages.

Another innovative aspect of the subject matter described in this disclosure can be implemented in a device, including at least one conductive component configured to place the device in electrical communication with an electromechanical systems (EMS) device to be tested; and a processor in electrical communication with the at least one conductive component, wherein the processor is configured to measure a release voltage of the EMS device at more than one point in time; and estimate a remaining lifetime of the EMS device based at least in part on the measured release voltages.

The processor can also be configured to initiate a calibration operation on the EMS device. The processor can also be configured to determine whether the estimated remaining lifetime of the EMS device is below a threshold. The processor can also be configured to select an application for the device based at least in part on the estimated remaining lifetime of the device

Details of one or more implementations of the subject matter described in this specification are set forth in the accompanying drawings and the description below. Although the examples provided in this disclosure are primarily described in terms of electromechanical systems (EMS) and microelectromechanical systems (MEMS)-based displays, the concepts provided herein may apply to other types of displays, such as liquid crystal displays, organic light-emitting diode (“OLED”) displays and field emission displays. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a system for testing an electromechanical systems (EMS) device.

FIG. 10 shows an example of a plot of a percentage decrease in release voltage of an EMS device as a function of a representative lifetime variable.

FIG. 11 shows an example of a flow diagram illustrating a method of determining a lifetime of an EMS device.

FIG. 12 shows an example of a flow diagram illustrating a method of binning an EMS device based on an estimated remaining lifetime of the device.

FIG. 13 shows an example of a flow diagram illustrating a method of estimating a remaining lifetime of an EMS device in conjunction with a calibration operation.

FIG. 14 shows an example of a flow diagram illustrating another example of a method of determining a lifetime of an EMS device in conjunction with a calibration operation.

FIG. 15 shows an example of an input waveform which may be used in identifying a release voltage of an EMS device.

FIG. 16 shows an example of a schematic diagram of a circuit which can be used to monitor the state of an EMS device.

FIGS. 17A and 17B show examples of system block diagrams illustrating a display device that includes a plurality of interferometric modulators.

Like reference numbers and designations in the various drawings generally indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various parametric characteristics of an EMS device can be measured, including release voltages, actuation voltages, and hold voltages. These parametric characteristics may change over a lifetime of the device, due to changes in the device, until the device eventually fails. A possible change in these parametric characteristics over time can be modeled, and measurements of a parametric characteristic at more than one point in time can be used in conjunction with a model of the device to estimate when the device will fail, or to estimate a remaining lifetime of the device. In particular, the release voltage of an EMS device is a parametric characteristic which may not necessarily be charge dependent.

These estimations or predictions of remaining lifetime can be utilized in a screening process, such as for reliability stiction screening, in which a small portion of a batch of EMS devices (e.g., one in 100, or one in 1,000) are tested to provide an indication of the overall reliability of the batch of EMS devices. However, such an estimation or prediction can be made in a period of time which is significantly less than the overall lifetime of an EMS device, and can therefore be done without destroying or degrading the device. Because these tests are nondestructive, each EMS device may be tested to estimate a remaining lifetime of that particular device. All or part of this estimation may overlap with another testing process, such as a calibration operation, further minimizing any wear on the device resulting from this estimation process. In addition, this estimation may be performed at more than one point in the lifetime of an EMS device, to provide an updated estimated remaining lifetime of the device. This estimation may be used, for example, in conjunction with performing an initial calibration operation after manufacture of the device and/or in conjunction with a recalibration operation to recalibrate the device after it has been in use for some time. An indication of an estimate remaining lifetime of a device may be provided or displayed to a user (e.g., actual estimated remaining lifetime, or a warning when the estimated remaining lifetime drops below a particular threshold).

Particular implementations of the subject matter described in this disclosure can be implemented to realize one or more of the following potential advantages. Estimating a remaining lifetime of an EMS device may allow, e.g., a user to plan for the eventual failure of the device. For example, the user may replace or repair the device when it is about to fail. Alternatively, the device may be recalibrated to extend the remaining useful lifetime of the device. In addition, during manufacturing, determining an estimated lifetime for an EMS device may serve as a reliability metric. Estimating a remaining lifetime of a particular device also allows that device to be screened or binned in order to use the device in an application where the estimated remaining lifetime of the device is sufficient to meet the selected reliability parameters for that application. In addition, measurements of changes in parameters of a device over time can be used, in conjunction with predictive models of such changes, to identify or otherwise characterize specific failure modes of a device, and may be used as indicators.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectra of IMODs can create fairly broad spectral bands which can be shifted across the visible wavelengths to generate different colors. The position of the spectral band can be adjusted by changing the thickness of the optical resonant cavity, i.e., by changing the position of the reflector.

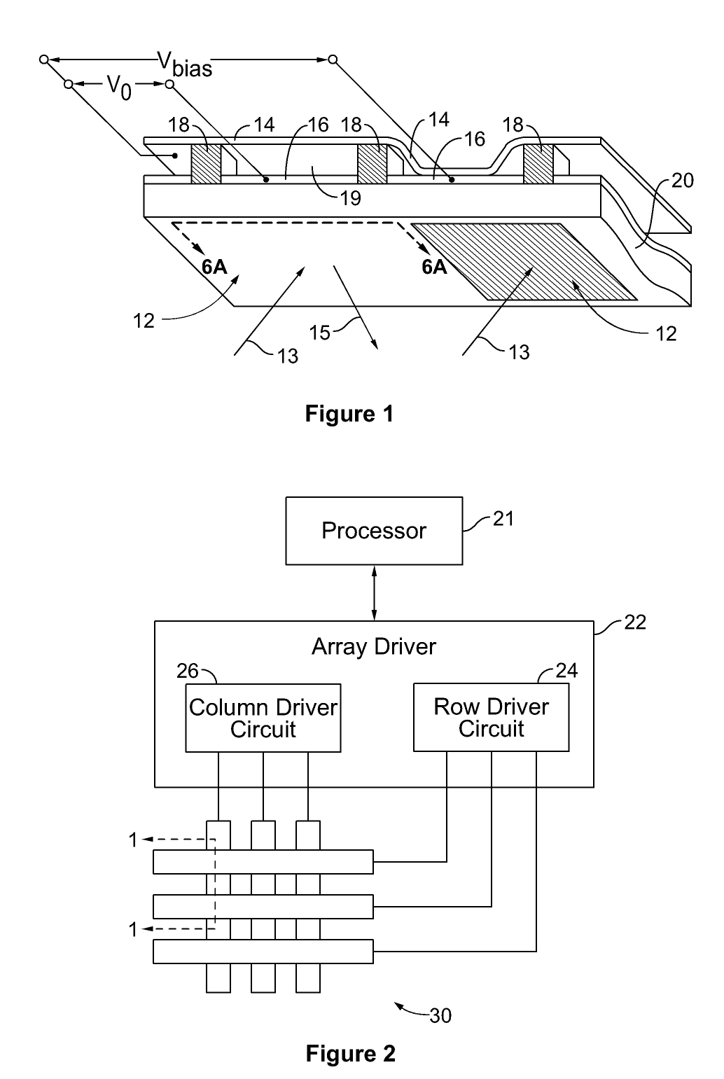

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

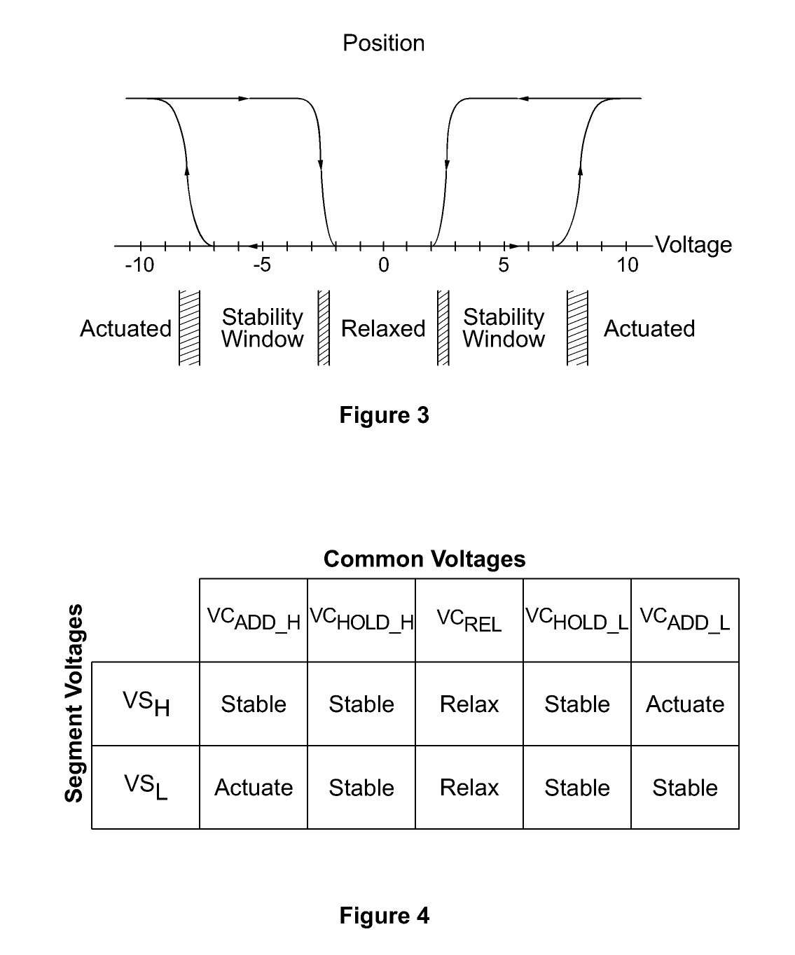

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

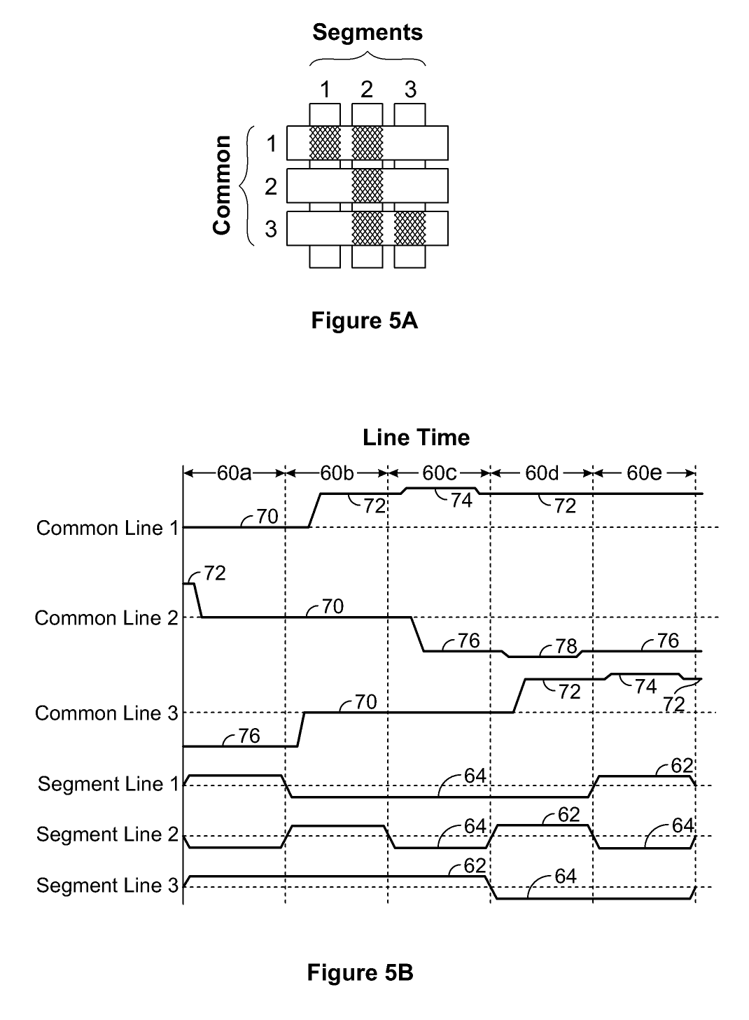

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

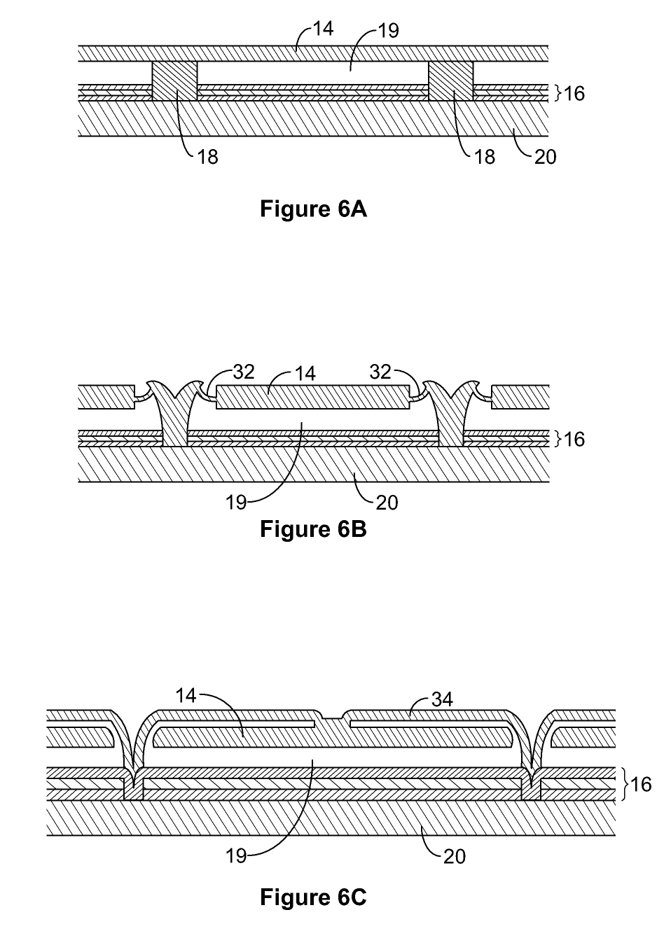

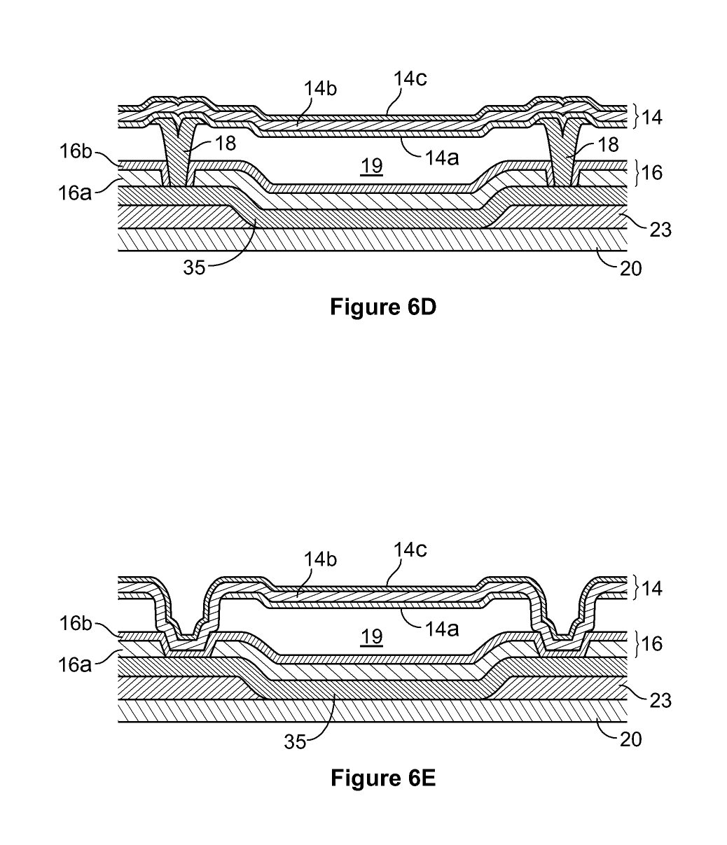

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

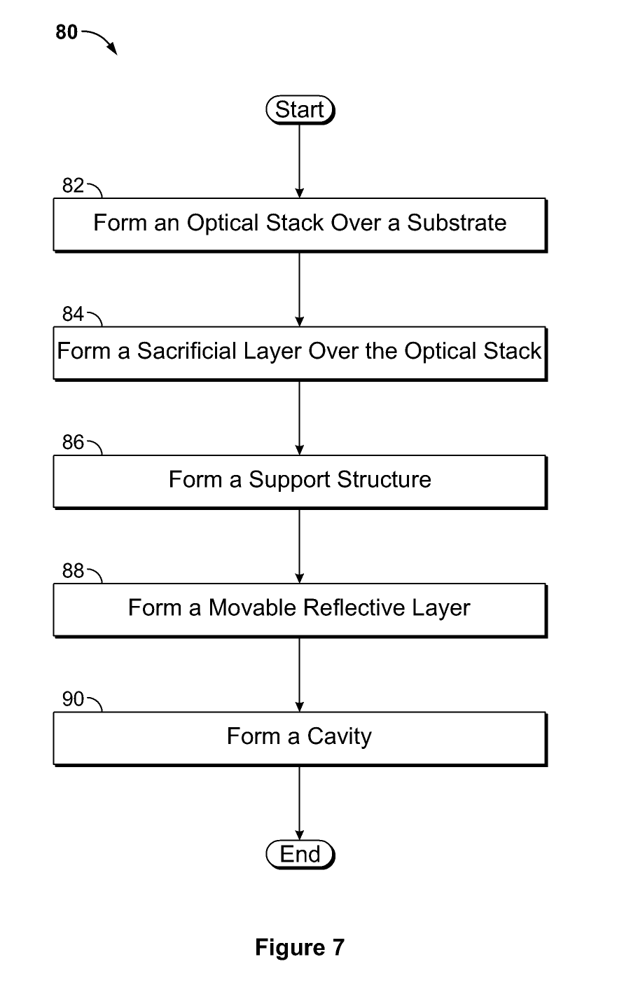

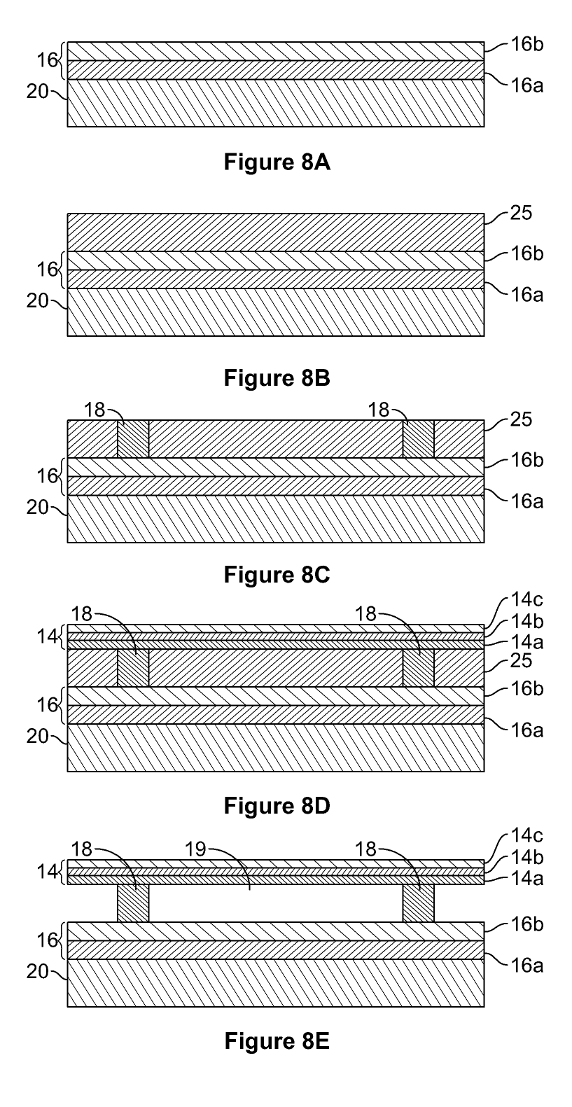

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20.

FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

In implementations such as those shown in FIGS. 6A-6E, the interferometric modulators function as direct-view devices, in which images are viewed from the front side of the transparent substrate 20, the side opposite to that upon which the modulator is arranged. In these implementations, the reflective layer 14 optically shields the portions of the interferometric modulator on the side of the reflective layer opposite the substrate 20, including the deformable layer 34. This allows the shielded areas to be configured and operated upon without negatively affecting the image quality. Such shielding allows the bus structure 34 in FIG. 6C, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the implementations shown in FIGS. 6C-6E may have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

At a point in time after fabrication of an electromechanical systems (EMS) device, one or more characteristics of the EMS device can be measured in order to provide information about the device. For example, certain EMS devices include at least one layer that is movable relative to other layers, and can be brought into contact with another layer. When the movable layer of the EMS device is electrostatically displaceable in response to an applied voltage across the device, various thresholds and voltage ranges may be measured which provide information about the current state of the device.

As discussed above with respect to FIG. 3, an EMS device such as an interferometric modulator may exhibit hysteresis, where application of any of a range of voltages between an actuation voltage and a release voltage will not cause a change in the state of the device. An actuation voltage of such a device is dependent upon the mechanical properties of the movable layer, and represents the point at which the electrostatic force resulting from accumulated charge on the movable layer and another electrode overcomes the restoring force of the mechanical layer. A release voltage of such a device is dependent not only on the mechanical properties of the movable layer and on the accumulated charge, but also on adhesion and/or stiction between the movable layer and the layer with which it is brought into contact.

Both the mechanical properties of the movable layer and the adhesion and/or stiction between layers may change over time. The restoring force of the movable layer may change over time, due to a change in the tensile stress within the movable layer or gap between layers. In contrast, adhesion and/or stiction between the layers brought into contact with one another also may change over time, due to changes in surface conditions and intermolecular forces within the EMS device. The change in the restoring force may cause a change in the absolute value of an actuation voltage. The increase in the adhesion and/or stiction forces between layers in contact with one another may change the absolute value of a release voltage, resulting in an overall change in the release voltage over time. Because both polarities of release voltages may change in a similar fashion, the term absolute value is used herein to indicate such similar changes to the magnitude of the release voltages, although the exact magnitudes of the release voltages may differ somewhat.

The magnitude of a release voltage of the EMS device may gradually change until the adhesive forces between the contacting surfaces exceed the mechanical restoring force of the movable layer such that the surfaces can no longer be separated even if there is no voltage is applied across the device. However, even a smaller change in the release voltage can complicate the operation of an EMS device, as an applied release driving voltage intended to release the device may no longer cause a device in an actuated state to release, or an applied hold voltage may cause a device in the actuated state to be released inadvertently. A threshold release voltage or percentage reduction in release voltage may therefore be designated as a failure state of the device. This threshold may be selected based on the type and use of the device. As noted above, the release voltage is dependent in part on factors which may change over the lifetime of the device, such as mechanical force, adhesion, and/or stiction between the movable layer and a layer with which it is brought into contact. Measurements of the release voltage at more than one point in time can therefore be used to provide an estimate of the remaining lifetime of the EMS device using a predictive model that takes into account the effect of, for example, evolving adhesion forces between layers within the device.

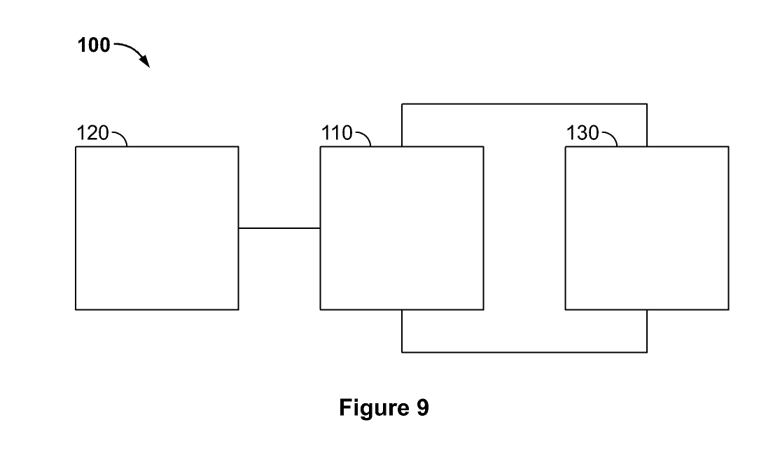

FIG. 9 shows an example of a system for testing an EMS device. The system 100 includes circuitry 110 configured to apply a voltage across a device such as EMS device 130. The circuitry 110 is in electrical communication with a processor 120, which is configured to measure a release voltage of the EMS device at more than one point in time and estimate a remaining lifetime of the EMS device based at least in part on the measured release voltages.

In some implementations, the system 100 may be integrated with the EMS device 130, such as in a display device or other such device. In some other implementations, the circuitry 110 and the processor 120 may form a part of a discrete system which can be brought into electrical communication with the EMS device 130, such as through the use of conductive members such as conductive probes or other suitable connectors. Such a stand-alone device may be used to test multiple EMS devices 130 in succession. In other implementations, some or all of the circuitry 110 may be integrated with the EMS device 130, and the processor 120 may be part of a discrete system configured to interface with the circuitry 110. In such implementations, circuitry 110 may be driver circuitry within a partially fabricated or completed EMS device, and the stand-alone testing device 130 may be configured to interact with the driver circuitry to perform a testing process.

The system 100 may measure a release voltage of the EMS device 130 at more than one point in time. In some implementations, these measurements occur over a period of several hours, although they may occur over longer or shorter periods of time in other implementations. The processor 120 may determine, for example, a percentage decrease in the release voltage over time based on the measured release voltages. The system also may fit the measured release voltages to a curve based on a model of the predicted change in the release voltage of the movable layer over time, and may use this information to predict the percentage decrease in the release voltage at a particular point in the future.

In some implementations, the percentage decrease in the release voltage (PDVᵣ) may be predicted, at least in part, using a model such as:

$$P D {V}_{r} = {k}_{1} [ 1 - exp ( - \frac{t}{{τ}_{1}} ) ] + {( \frac{t}{{τ}_{2}} )}^{{k}_{2}} ,$$

where t is a representative lifetime variable such as time or number of contact cycles and k₁, k₂, τ₁, and τ₂ are constants related to the physical characteristics of the device. These constants may be determined by fitting the model to the measurements. In some implementations, variations on the above model may be used, or other models may be used. In the above equation, the exponential term,

$${k}_{1} [ 1 - exp ( - \frac{t}{{τ}_{1}} ) ] ,$$

may estimate the effect of charge build up and the polynomial term,

$${( \frac{t}{{τ}_{2}} )}^{{k}_{2}} ,$$

may estimate the effect of surface changes or other mechanical changes which the device experiences.

As discussed above, the PDVᵣ is indicative of changes in the EMS device over time, particularly the effect of adhesion forces within the device. A PDVᵣ of 1.0 is indicative of total failure due to stiction, as the device will not release, regardless of the magnitude of the voltage applied across the device. However, a device may be considered to be in a failure state at a much lower PDVᵣ threshold, for the reasons discussed above.

In addition, although the following description generally discusses the calculation of a release voltage, many EMS devices include multiple EMS elements which may differ from one another in terms of structure or in terms of behavior over time. For example, in an EMS display device which includes an array of interferometric modulators of various colors, the different colors of interferometric modulators may have different release voltages, and these release voltages also may change in a different manner over time. In such an implementation, release voltages for each of the various colors of interferometric modulators may be measured separately. Even in an EMS device which includes multiple substantially identical EMS elements, release voltages of the EMS elements and the change in these release voltages over time may differ from one another.

Thus, depending on factors such as the processing power of the system, the methods and devices described herein may measure and analyze a plurality of release voltages, rather than a single voltage, and may calculate a plurality of values of an estimated remaining lifetime. In some implementations, the lowest of these estimated remaining lifetimes may be used as an estimate of the overall remaining lifetime of an EMS device. In some other implementations, the estimated overall remaining lifetime of the EMS device may otherwise be calculated based on the plurality of values for the estimated remaining lifetime. For the purposes of clarity, the discussion herein may refer to the measurement of a single release voltage, and a single estimation of remaining lifetime, but should be understood to also encompass the measurement of multiple release voltages and/or multiple estimations of remaining lifetime.

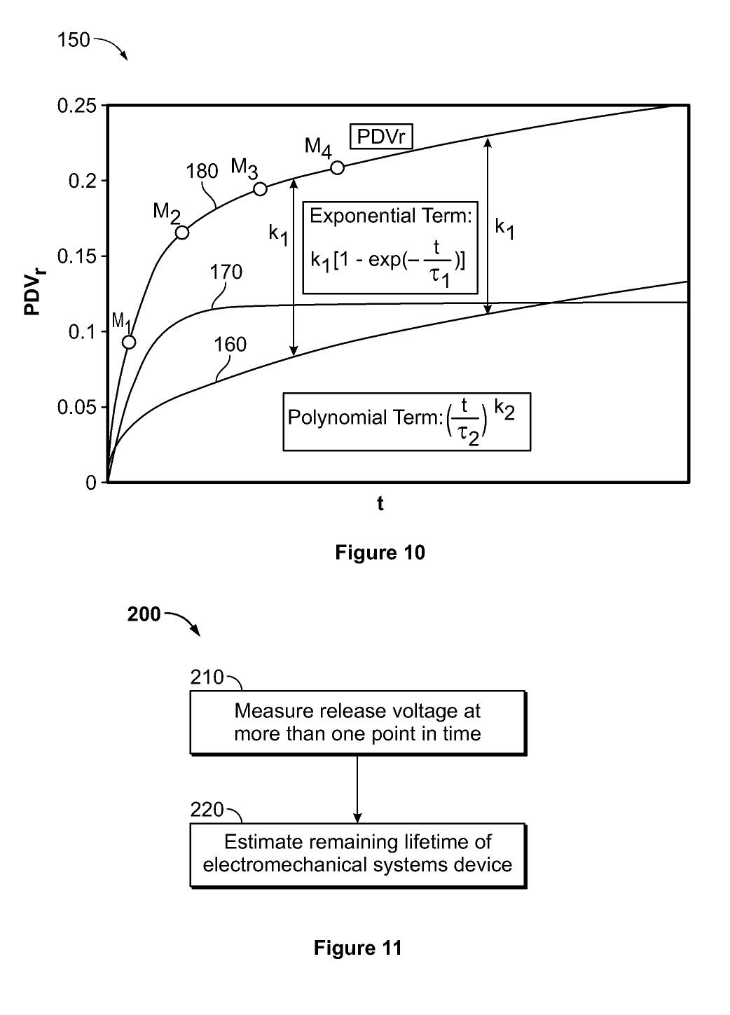

FIG. 10 shows an example of a plot of a percentage decrease in release voltage of an EMS device as a function of a representative lifetime variable. In particular, FIG. 10 shows a plot 150 of the polynomial term 160, the exponential term 170, and total PDVᵣ 180 according to the above model for some values of k₁, k₂, τ₁, and τ₂, over a time scale of arbitrary units. In the example shown in FIG. 10, measurements taken at points M₁, M₂, M₃, and M₄ are indicated on the curve illustrating total PDVᵣ 180. Once measurements of the release voltage are used to determine the constants of the PDVᵣ model, the PDVᵣ model can be used by the processor to estimate a lifetime or remaining lifetime of the device.

FIG. 11 shows an example of a flow diagram illustrating a method of determining a lifetime of an EMS device. At block 210 of method 200, the release voltage of an EMS device is measured at more than one point in time. At block 220, the remaining lifetime of the device is estimated based on the measured release voltage.

At block 210, the release voltage may be measured at various times while the device is evolving, where a time of measurement is recorded and associated with each measurement result. In the example shown in FIG. 10, measurements are taken at four different points M₁, M₂, M₃, and M₄. In some implementations, during the time between measurements, the environment of the device is controlled so that the aging of the device is accelerated, such that the time between the measurements is representative of a greater time of use than has actually taken place. For example, if the temperature is increased, the change in release voltage may be accelerated according to a known relationship between temperature and time. Other acceleration methods may include controlling humidity, air pressure, an input voltage, or an input frequency. As noted above, in some implementations, another characteristic of the EMS device, such as an actuation voltage or a hold voltage may be measured in addition to or instead of a release voltage.

At block 220 the lifetime of the device is estimated based on the measured release voltages. In one example, the model of PDVᵣ discussed above is used. The measurements are fitted to the PDVᵣ curve, as shown in FIG. 10. In one implementation utilizing the above model for PDVᵣ, fitting the measurements to the PDVᵣ curve includes determining values for the constants k₁, k₂, τ₁, and τ₂ based on the measured release voltages. In some implementations, estimating the remaining lifetime of the device includes estimating at which point in time PDVᵣ will reach a selected threshold, taking into account any accelerated aging to which the device was exposed. The selected threshold will vary based upon a variety of factors including the intended use of the device and tolerance of failure of the device. The PDVᵣ threshold may be anywhere between about 0.05 to about 1.0. In some implementations, the PDVᵣ threshold may be about 0.2, about 0.3, or about 0.4. In some implementations, the PDVᵣ threshold may be about 0.9, or about 0.95, or about 1.0.

Once the processor has estimated the remaining lifetime of an EMS device, the processor may then use the estimated lifetime to determine whether the device has a satisfactory level of expected reliability. As discussed in greater detail below, this determination can be used to determine whether a device is defective, or can be used to select appropriate devices for use in a specific application.

In some implementations, a measurement other than a release voltage is used in conjunction with a model to estimate a remaining lifetime of a display device. For example, in some implementations, an actuation voltage or a range of hold voltages may be measured and used in conjunction with a model to estimate a remaining lifetime of a device or another characteristic of the display device.

For example, an actuation voltage may be used in addition to the release voltage to estimate the lifetime of the EMS device. In some implementations, the release voltage may be temporarily affected by humidity or other environmental conditions. By measuring the actuation voltage in addition to the release voltage, the system can correct for variance in a measured release voltage due to temporary conditions such as changes in humidity. For example, if the release voltage decreases, but the ratio of the release voltage and the actuation voltage remain substantially constant, the decrease in release voltage may be ignored or otherwise accounted for without treating the change in release voltage as indicative of the remaining lifetime of the device.

In some implementations, an array of EMS devices, such as a display, includes a plurality of EMS elements or devices. For example, a display may include thousands to millions of EMS elements. A remaining lifetime may be calculated for the device by measuring the decrease in release voltage for one or more of the elements in the array. In some implementations, the lifetime of a display or a device within the display is determined based on a distribution of release voltages measured from a plurality of the elements in the array. For example, an average of the measured release voltages may be used to determine the lifetime, or the measured release voltage having the lowest magnitude may be used. In an implementation in which there are differences in the initial release voltages of the elements in the array, the lowest PDVᵣ of the measured devices may be used. The release voltage having the lowest magnitude or PDVᵣ may be indicative of the element with the shortest expected remaining lifetime. In some implementations, the minimum release voltage for a plurality of elements may be determined without measuring the release voltage of each of the plurality of elements individually, by collectively testing the array or a subset of the elements within the array, such as a row or a column of elements within the array. Thus, the lifetime of the overall array also may be calculated based upon the minimum expected lifetime of a device within the array.

An estimation of the lifetime of an EMS device may be made at any point within the lifetime of the device. For example, the estimated remaining lifetime of an EMS element within a display may be calculated during manufacturing, during calibration or self-calibration of the display, or after a user has purchased and begun using the display. In some implementations, testing of the device is combined with conditioning and/or burn-in of the device during manufacturing. Testing the device in this way may shorten the period of time used to determine the estimation. Testing the EMS device as part of a conditioning process also may avoid substantial loss of remaining lifetime potentially caused by the testing. Because the drop in the release voltage can be correlated to panel release performance, as discussed above, reliability screening may be performed during manufacturing by measuring a reduction in release voltage and comparing the result with a limit or threshold indicative of a desired reliability level. Further, estimated lifetime can be used during manufacturing to screen whether the device has an estimated remaining lifetime in excess of a product specification lifetime.

In some implementations, the device or the display may be classified based at least in part on the estimated remaining lifetime. For example, a product requiring high reliability for an extended period of time may have a specification which calls for an estimated device lifetime greater than the remaining lifetime estimated for a particular tested device. That tested device would not be appropriate for that high reliability product. However, a second product may have a more relaxed lifetime reliability threshold, which the tested device meets. Accordingly, the estimated lifetime of the tested device indicates that the tested device would be suitable for use in the second product. By “binning” the tested devices, i.e., by selecting them for a particular use based on their estimated remaining lifetime, the overall reliability of the products can be improved, as such a binning process allows the selection of tested devices for use in products only when their estimated remaining lifetime exceeds the desired level for that product. Devices which do not reach the threshold of estimated remaining lifetime for any products can be discarded or otherwise processed as unsatisfactory.

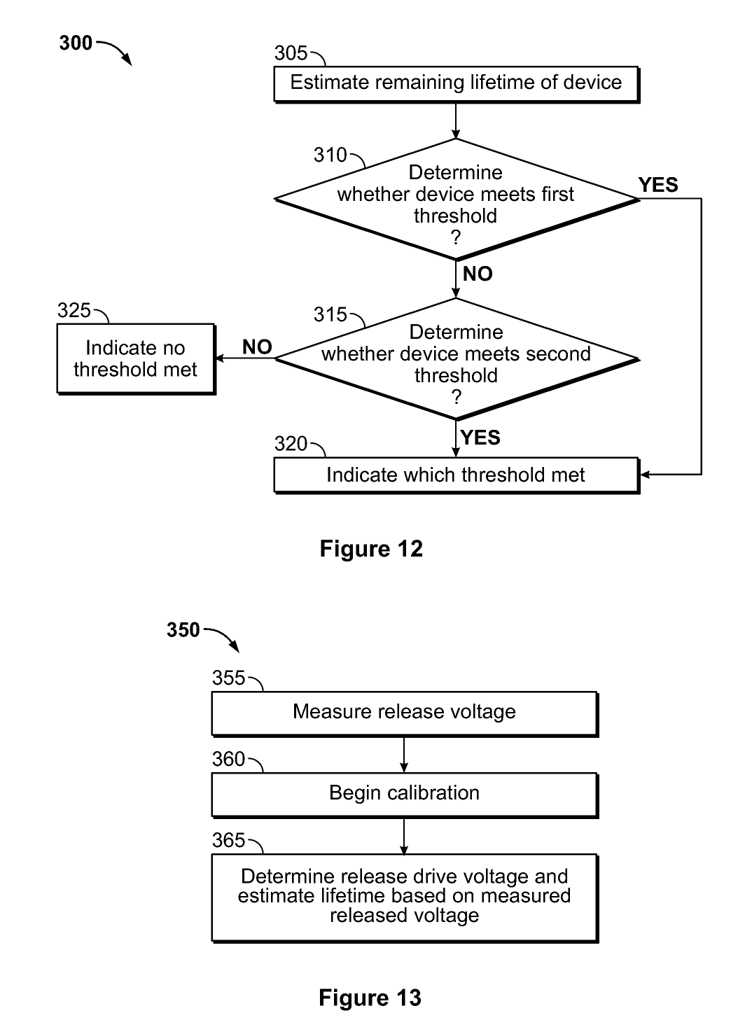

FIG. 12 shows an example of a flow diagram illustrating a method of binning an EMS device based on an estimated remaining lifetime of the device. In the method 300 illustrated in FIG. 12, a device is binned into one of three quality levels based on two thresholds, which in some implementations may be estimated remaining lifetimes or parameters indicative of an estimated remaining lifetime, such as a PDVᵣ after a testing process. In some implementations, first and second thresholds may be defined, with the first threshold being more stringent than the second threshold. In the first quality level, the tested device meets the first threshold (and by definition the less stringent second threshold). In the second quality level, the tested device meets the second threshold, but not the more stringent first threshold. In the third quality level, the tested device meets neither the first nor the second threshold.

The method 300 begins at a block 305, where the remaining lifetime of the device is estimated using a method such as that described above. At block 310, a determination is made as to whether the device meets a first threshold. If the device meets the first threshold, such as by having an estimated remaining lifetime exceeding that defined by the first threshold, the process proceeds to block 320 and the device is indicated as having met the first threshold. If the device does not meet the first threshold, the process proceeds to a block 315 where a determination is made as to whether the device meets a second threshold. If the device meets the second threshold, the process proceeds to block 320 and the device is indicated as having met the second threshold. If the device does not meet the second threshold, the process proceeds to block 325 and the device is indicated as not having met either threshold.

For example, the estimated remaining lifetime of a tested device may be 4.3 years, the first threshold may be an estimated remaining lifetime of 5 years, and the second threshold may be an estimated remaining lifetime of 3 years. Using the method described above with reference to FIG. 12, the tested device would be indicated as having met the second threshold. Accordingly, the device would be available for use in a product having a lifetime specification of 3 years, and would not be available for use in a product having a lifetime specification of 5 years. Although the above implementation determines whether the device meets two separate thresholds, some other implementations of binning methods can include only a determination as to whether the device meets a single threshold, can include determinations as to whether the device meets more than two separate thresholds.

In some implementations, an estimated remaining lifetime of an EMS device may be determined once the device has been integrated into a finished device such as a display device. In such implementations, the remaining lifetime of the device may be estimated during use of the EMS device, such as after the finished device has been sold to, e.g., a user.

In some implementations, such a determination may be triggered by user action. In some other implementations, the determination may be made as part of a calibration process, a self-calibration process, or as part of a startup routine. In other implementations, the determination may be triggered automatically in response to an event, such as the passage of a certain amount of time, or a change in a measured parameter. In some implementations, if a device is nearing the end of its estimated life, or if a measured release voltage has dropped beyond a given threshold, the device may be configured to determine an estimated remaining lifetime of the device.

In some implementations, previously determined estimates of remaining lifetime for a particular device are recorded in a computer-readable memory or other storage and are available to a processor configured to estimate a remaining lifetime of a device. In some implementations, additional information relating to previously determined estimates of remaining lifetime are also available, such as previous release voltage measurements and the times of such measurements, and/or previously calculated model parameters. New release voltage measurements may be taken to provide an updated estimate of the remaining lifetime of the device. In some implementations, the updated determination of an estimated remaining lifetime may be made using previously calculated model parameters in conjunction with one or more recently measured release voltages. Alternatively, in some implementations, at least some of the model parameters may be recalculated based at least in part on one or more recently measured release voltages.

For example, an estimated remaining lifetime may be calculated for a particular device shortly after manufacturing of the device, based upon a particular PDVᵣ which has been identified as a failure state of the device. At a later point, after the device has been in use for some time, a release voltage may be measured, and the newly measured release voltage may be used to recalculate the estimated remaining lifetime of the device. In some implementations, previously calculated model parameters may be used in conjunction with the new release voltage measurement to update the estimated remaining lifetime of the device. In other implementations, one or more new release voltage measurements may be fitted to the PDVᵣ model by recalculating one or more model parameters based at least in part on the new release voltage measurements. Once the model parameters have been recalculated, they can update the estimated remaining lifetime of the device by calculating the estimated time for the PDVᵣ to increase from its current value to the value selected as a failure state for the device.

An estimated remaining lifetime may be provided to, e.g., a user of the device, such as by displaying the estimated remaining lifetime for the user to observe. In some implementations, if the remaining lifetime of the device is less than a threshold, a warning message is displayed. Such advance notification may allow the user to repair or replace the device at their convenience, instead of responding to the failure once the device unexpectedly fails.

In some implementations, if a sudden change in a measured release voltage of an EMS device is detected, a shutdown of a system including the device may be initiated based at least in part on the sudden change in the measured release voltage. For example, if a change in measured voltage over a period of time exceeds a particular threshold, operation of the EMS device may be suspended. Such a sudden change in the release voltage may occur, for example, as a result of a change in an operating environment condition, such as temperature, pressure or humidity. Suspending the operation of the EMS device may protect the system from harm caused by the environmental condition resulting in the sudden change in release voltage, as operation of the device under such conditions could shorten the lifetime of the device. For example, if the device is dropped, resulting in a change in the pressure to which the EMS device is exposed, the measured change in release voltage may exceed a threshold, and operation of the EMS device may be suspended to prevent further damage to the device.

In response to determinations of estimated lifetime made during use of an EMS device, a device may initiate an operation to extend the lifetime of the device. In some implementations, this operation may include a recalibration operation to adjust the driving voltages applied to the device in order to ensure that the device is actuated and released as intended. For example, driver circuitry connected to the device may be configured to apply a release drive voltage across a device in order to release the device. However, over time, the magnitude of the release voltage of the device may decrease to a magnitude less than the release drive voltage which the driver circuitry is configured to apply. Because of this, in some implementations, the threshold used to determine an estimated lifetime is determined at least in part by a drive release voltage used by the device. By recalibrating the device at some point during the lifetime of the device to reduce the magnitude of the release drive voltage, an estimated remaining lifetime of the device can be increased.

In some other implementations, a device may initiate a refresh or recovery operation upon a determination of estimated remaining lifetime, or the device may alert a user to initiate the same. For example, a user may be alerted to send the device to a repair service which may perform such an operation. As noted above, a buildup of moisture in the device may increase the adhesion and/or stiction between layers within the device, lowering the magnitude of a release voltage of the device and reducing an estimated remaining lifetime of the device. Performing a refresh operation, which in one implementation includes exposing the device to a heated environment or a low-humidity environment, can remove at least some of the moisture and extend estimated lifetime of the device. Other refresh operations also may be used. An updated estimated remaining lifetime of the device may then be calculated to determine the effect of the refresh operation on the estimated lifetime of the device.

FIG. 13 shows an example of a flow diagram illustrating a method of estimating a remaining lifetime of an EMS device in conjunction with a calibration operation. Although generally described as a calibration operation, the calibration operation may in some implementations be an initial calibration operation performed shortly after manufacture of the EMS device, and in other implementations may be a recalibration operation performed after the device has been used for a period of time.

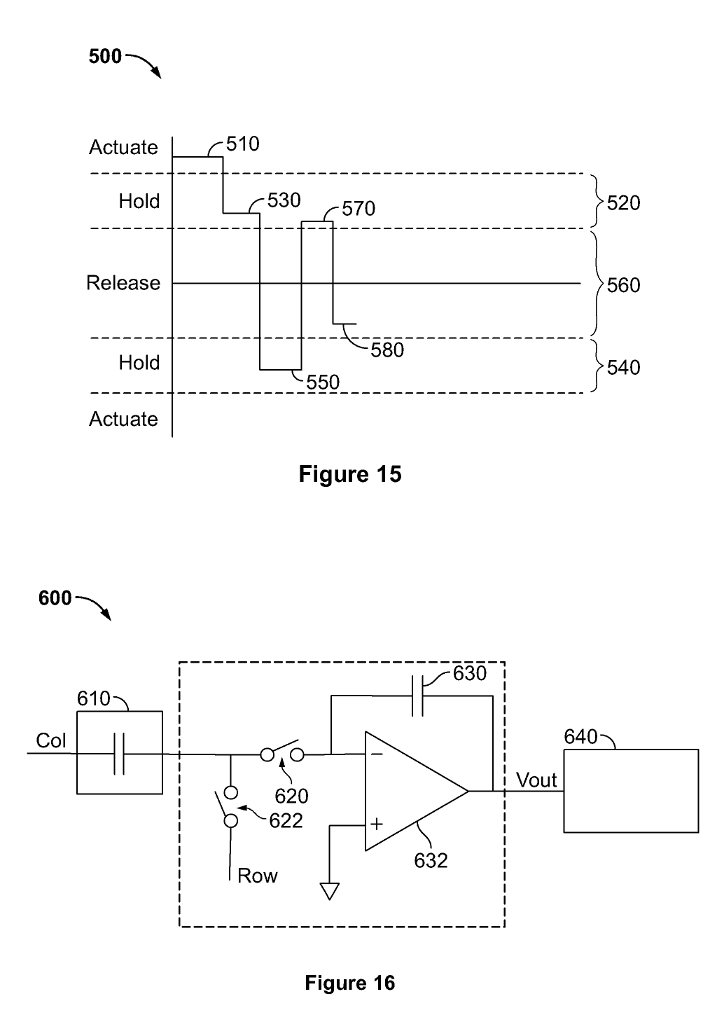

The method 350 of FIG. 13 begins at block 355, where a release voltage of the device is measured using any suitable method, including methods such as those described in greater detail with respect to FIGS. 15 and 16 below. In some implementations, multiple measurements may be taken over a period of time. In some implementations, the device may be exposed to accelerated aging conditions during a period of time over which the measurements are taken.

At block 360, a calibration operation of the device begins. The calibration operation may include one or more measurements of various parameters of the device. For example, calibration measurements of actuation, release, and hold thresholds may be performed by any suitable method. The calibration measurements may be used, for example, to provide data for determining or selecting various driving and bias voltages for operating the device. Although the measurement of the release voltages in block 355 and the beginning of the calibration operation in block 360 are depicted in FIG. 13 as separate blocks, the release voltage measurements may in some implementations be a part of or overlap with the calibration operation.

At block 365, as part of the calibration algorithm, a release drive voltage is determined based at least in part on the release voltage measured at 355. In addition, the lifetime of the device is estimated based at least in part on the release voltage measured at 355. As discussed above, the release drive voltage may generally have a magnitude less than the measured release voltage, to account for an eventual decrease in the magnitude of the release voltage of the device over time. Using at least some of the same measurements for both calibration and lifetime estimation can save time and cost in the testing process and reduce wear on the device resulting from the testing process. In some implementations, a release drive voltage may be selected in order to provide a desired estimated remaining lifetime. In a particular implementation, selecting a release drive voltage may include identifying a predicted PDVᵣ at the end of the desired remaining lifetime and using the predicted PDVᵣ to select or determine an appropriate release drive voltage.

In the illustrated implementation, the method 350 includes measuring at least one release voltage prior to beginning the calibration operation. In some implementations, at least some of the release voltage measurements used in the determination of the remaining estimate lifetime are performed during the calibration operation. In some other implementations, all release voltage measurements used in the determination of the remaining estimate lifetime are performed during the calibration operation. In some implementations where the calibration operation is a recalibration operation, at least one release voltage measurement performed during the recalibration operation is used in conjunction with at least one previously measured and stored release voltage measurement to determine an updated estimated remaining lifetime of a device. As discussed in greater detail below, other implementations may include performing additional release voltage measurements after the calibration operation is completed.

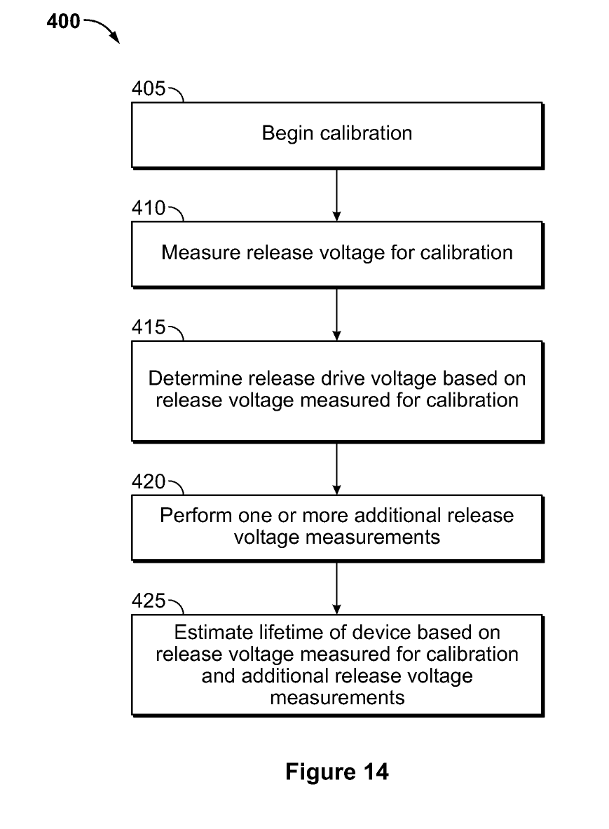

FIG. 14 shows an example of a flow diagram illustrating another example of a method of determining a lifetime of an EMS device in conjunction with a calibration operation. The method 400 of FIG. 14 begins at a block 405, where a calibration operation begins. As discussed above, the calibration operation may be used to determine, for example, driving voltages to be applied to a device, and may be either an initial calibration operation or a recalibration operation performed after the device has been in use for some time. At block 410, at least one release voltage is measured as part of the calibration operation. The measurement data may be stored so it can be used both for the calibration operation calculations and for the calculations used to determine an estimated lifetime of the device.

At block 415, the calibration operation determines a release drive voltage based on the measurement taken at 410. The calibration operation may use one or more of the processes described herein to perform this determination, or may use any other suitable process.

At block 420, additional release voltage measurements may be taken. As discussed above, in some implementations the measurements taken during a calibration operation may be sufficient to determine an estimated remaining lifetime of the device, and no additional release voltage measurements may be performed after the calibration operation is completed. In some implementations, the device may be exposed to accelerated aging conditions between or during the release voltage measurements.

At block 425, the remaining lifetime of the device is estimated based at least in part on the at least one release voltage measured at block 410 and any additional release voltage measurements taken at block 420. As in the method of FIG. 13, using at least some of the same measurements for both a calibration operation and for the estimation of remaining lifetime can save time and cost in the testing process as well as minimize additional wear on the device.

In some implementations, a display panel may be divided into multiple areas, where threshold measurements are independently taken and tracked for each of the areas. The system may find an area which is stressed more or aging faster than other areas. The stressed area can be preferentially monitored for drop in release voltage to better predict when and where failure may occur.

A variety of methods and devices may be used to carry out the measurement of the release voltages discussed above. In some implementations, the EMS device is driven to an actuated state, and a series of steadily decreasing voltages is applied to the device. The state of the device is then monitored to identify the point at which the device releases, and the most recently applied voltage provides an indication of a release voltage of the EMS device. In a particular implementation, a series of steadily decreasing voltages may be applied to a device by applying an appropriate input waveform.

FIG. 15 shows an example of an input waveform which may be used in identifying a release voltage of an EMS device. The waveform 500 begins at an actuation voltage 510 which has a magnitude greater than the upper bound of positive hold window 520 of the device. The voltage then drops to a hold voltage 530 which is within the positive hold window of the device, such that the device remains in an actuated state. The voltage is then switched to a first negative test voltage 550 which has a smaller magnitude than the hold voltage 530 and the opposite polarity. Because the first negative test voltage 550 is within the negative hold window 540 of the device, the device remains in an actuated position. The voltage is then switched to a first positive test voltage 570, which has a smaller magnitude than the first negative test voltage 530 and the opposite polarity. The voltage continues to be switched between test voltages of decreasing magnitude and opposite polarities. In the illustrated implementation, the voltage moves next to a second negative test voltage 580 which has a magnitude having an absolute value less than that of the lower bound of the negative hold window 540, and is within the release voltage window 560. At this point, the device releases, and the second negative test voltage 580 provides an indication of a release voltage of the device.

The granularity of the magnitude differences may be selected to provide a desired level of resolution in the measured release voltage. For example, when the differences in magnitude between the stepped voltages are reduced, the accuracy of the measured release voltage is increased. In an alternate implementation, the polarity of the applied voltage is not switched as the magnitude of the applied voltage decreases. Rather, the applied voltage may be decreased in a stepped manner until the device releases.

A variety of methods and devices may be used to monitor the state of the EMS device in order to identify the point at which the device releases from an actuated state to a released state. In some implementations, the state of the EMS device may be monitored visually, either by an observer or by an optical measurement device. Additionally or alternatively, the state of the EMS device may be monitored through electronic measurement. As discussed above, in some implementations, a discrete testing system is utilized, whereas in other implementations, the testing system may be integrated with a finished device, such as in a driver chip or processor within a display device.

As discussed above, certain implementations of EMS devices include a conductive movable layer and another electrode used to electrostatically actuate the conductive movable layer. In such a device, the conductive movable layer and the other electrode function as the two plates in a capacitor. Because the capacitance of the device varies based upon the position of the movable layer, the capacitance in an actuated state will be greater than that of the capacitance in a relaxed or released state. Therefore, an indication of the capacitance can be used to determine the state of the EMS device.

An indication of the capacitance can be obtained, for example, by sensing the current or charge used to change the voltage applied between the movable layer and the other electrode. A relatively high amount of current or charge indicates that the capacitance is relatively large. Similarly, a relatively low amount of current or charge indicates that the capacitance is relatively small. The sensing of current or charge may be accomplished, for example through analog or digital integration of a signal representing the charge or current.

FIG. 16 shows an example of a schematic diagram of a circuit which can be used to monitor the state of an EMS device. In particular, FIG. 16 shows a sensor circuit 600 which can be used to sense the current used when driving an EMS device 610. Switches 620 and 622 can be used to control the operation of sensor circuit 600. The sensor circuit 600 includes an integrator circuit which includes a capacitor 630 and an operational amplifier 632. In a first configuration, switch 622 is closed, while switch 620 is held open. The voltage across the EMS device 610 is equal to the current value of the voltage difference between the Col and Row voltages. Any changes in the voltage difference result in current flow through the EMS device 610. In such an implementation, the output voltage Vₒᵤₜ of the sensor circuit 600 will not be affected, because the switch 620 disconnects the EMS device 610 from the capacitor 630 and the operational amplifier 632. This first arrangement of switches 620 and 622 can be used to initialize the EMS device 610 by placing the EMS device 610 in an actuated state. Also shown in FIG. 16 is a processor 640 in electrical communication with the output voltage Vₒᵤₜ of the sensor circuit 600, which may be configured to analyze the output voltage Vₒᵤₜ of the sensor circuit 600.

In a second configuration, the switch 620 is closed, while the switch 622 is held open. Any changes in the voltage difference again result in current flow through the EMS device 610. However, in this second configuration, the capacitor 630 and operational amplifier 632 are in electrical communication with the EMS device 610 via closed switch 620, and are thus exposed to the current flow through the EMS device 610. In this second configuration, the output voltage Vₒᵤₜ of the sensor circuit 600 is proportional to the charge transfer through the EMS device 610. Accordingly, the sensor circuit 600 of FIG. 16 can be used to sense the current or charge used to drive the EMS device 610 and determine the state of the EMS device 610. In some implementations, the Col and Row voltages may be signals other than column and row voltages. For example, one of the Col and Row voltages may be grounded. In some implementations, the sensor circuit 600 includes a reset circuit configured to reset the output voltage Vₒᵤₜ of the sensor circuit 600 when desired.

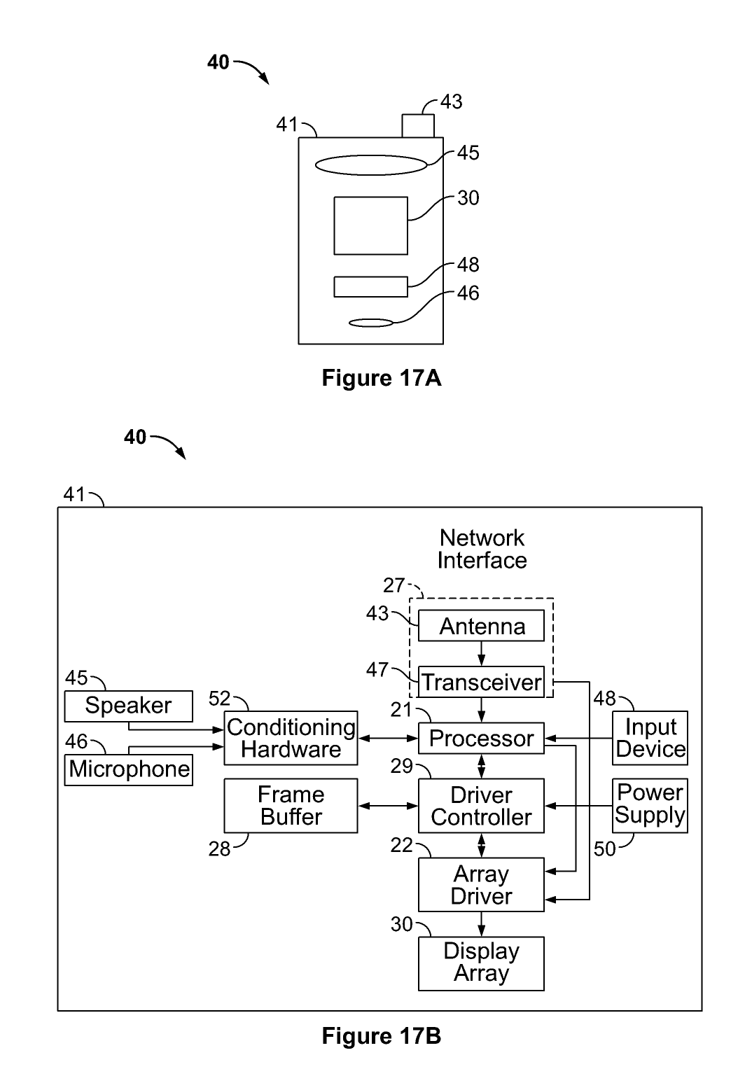

FIGS. 17A and 17B show examples of system block diagrams illustrating a display device 40 that includes a plurality of interferometric modulators. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 17B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device, comprising:
circuitry configured to apply a driving voltage across a electromechanical systems (EMS) device; and
a processor, wherein the processor is configured to:
measure a release voltage of the EMS device at more than one point in time; and
estimate a remaining lifetime of the EMS device based at least in part on the measured release voltages.

2. The device of claim 1, wherein the processor is configured to estimate the lifetime based at least in part on a model of the release voltage of the device as a function of time.

3. The device of claim 1, wherein the processor is further configured to determine a percentage decrease in the release voltage (PDVᵣ).

4. The device of claim 3, wherein the processor is further configured to estimate a remaining lifetime of an EMS device based at least in part upon a model of a predicted PDVᵣ of the device as a function of time.

5. The device of claim 3, wherein the processor is further configured to estimate a remaining lifetime of the EMS device by calculating a PDVᵣ of the device at a point in the future based at least in part on the following model:
$$P D {V}_{r} = {k}_{1} [ 1 - exp ( - \frac{t}{{τ}_{1}} ) ] + {( \frac{t}{{τ}_{2}} )}^{{k}_{2}} ,$$
wherein t is a lifetime variable, and k₁, k₂, τ₁, and τ₂ are constants.

6. The device of claim 5, wherein the processor is further configured to determine values for the constants k₁, k₂, τ₁, and τ₂ by fitting the plurality of release voltage measurements to the model.

7. The device of claim 1, wherein the processor is further configured to initiate a calibration operation on the EMS device.

8. The device of claim 7, wherein the processor is further configured to:
determine whether the estimated remaining lifetime of the EMS device is below a threshold; and
initiate a calibration operation in response to a determination that the estimated remaining lifetime is below the threshold, wherein the calibration operation is a recalibration operation.

9. The device of claim 1, wherein the processor is further configured to determine whether the estimated remaining lifetime of the EMS device is below a threshold.

10. The device of claim 9, wherein the processor is further configured to assign a quality level to the device in response to the determination of whether the estimated remaining lifetime of the EMS device is below a threshold.

11. The device of claim 9, wherein the processor is further configured to identify the device as defective in response to a determination that the estimated remaining lifetime is below the threshold.

12. The device of claim 1, wherein the processor is further configured to select an application for the device based at least in part on the estimated remaining lifetime of the device.

13. The device of claim 1, wherein the processor is further configured to screen the device for failure due to stiction based at least in part on the estimated remaining lifetime of the device.

14. The device of claim 1, wherein the circuitry is configured to apply driving voltages across at least two EMS elements within the EMS device, and wherein the processor is configured to measure a release voltage of each of the at least two EMS elements at more than one point in time.

15. The device of claim 1, wherein the processor is further configured to suspend operation of the EMS device if a change in the release voltage over a period of time exceeds a threshold.

16. The device of claim 1, wherein the processor is further configured to estimate an updated remaining lifetime of the EMS device subsequent to estimating a remaining lifetime of the EMS device.

17. The device of claim 14, wherein the device is configured to store data related to at least one release voltage measurement, and wherein the processor is configured to estimate an updated remaining lifetime of the EMS device based at least in part on the stored data.

18. The device of claim 1, further comprising:
a display including the EMS device; and
a memory device that is configured to communicate with the processor, wherein the processor is further configured to process image data.

19. The device of claim 18, further comprising a controller configured to send at least a portion of the image data to the circuitry configured to apply a driving voltage across the EMS device.
The device of claim 18, further comprising an image source module configured to send the image data to the processor, wherein the image source module includes at least one of a receiver, transceiver, and transmitter.

20. The device of claim 18, further comprising an input device configured to receive input data and to communicate the input data to the processor.

21. A method of testing an electromechanical systems (EMS) device, comprising:
measuring a release voltage of an EMS device at more than one point in time to obtain a plurality of measured release voltages; and
estimating a remaining lifetime of the EMS device based at least in part on the measured release voltages.

22. The method of claim 21, further comprising determining a percentage decrease in the release voltage (PDVᵣ).

23. The method of claim 22, further comprising estimate a remaining lifetime of an EMS device based at least in part upon a model of the predicted PDVᵣ of the device as a function of time.

24. The method of claim 21, additionally comprising determining whether the estimated remaining lifetime of the EMS device is below a threshold.

25. The method of claim 24, additionally comprising performing a recalibration operation in response to a determination that the estimated remaining lifetime of the EMS device is below the threshold.

26. A computer readable medium, comprising instructions, which, when executed cause the computer to perform the method of claim 21.

27. A device, comprising:
circuitry configured to apply a driving voltage across a electromechanical systems device (EMS); and
means for estimating a remaining lifetime of the EMS device based at least in part on measured release voltages of the EMS device.

28. The device of claim 27, wherein the estimating means include a processor, the processor configured to:
measure a release voltage of the EMS device at more than one point in time; and
estimate a remaining lifetime of the EMS device based at least in part on the measured release voltages.

29. A device, comprising:
at least one conductive component configured to place the device in electrical communication with an electromechanical systems (EMS) device to be tested; and
a processor in electrical communication with the at least one conductive component, wherein the processor is configured to:
measure a release voltage of the EMS device at more than one point in time; and
estimate a remaining lifetime of the EMS device based at least in part on the measured release voltages.

30. The device of claim 29, wherein the at least one conductive component is a conductive probe.

31. The device of claim 29, wherein the at least one conductive component is configured to place the processor in electrical communication with circuitry configured to apply a driving voltage across the EMS device.

32. The device of claim 29, wherein the processor is further configured to initiate a calibration operation on the EMS device.

33. The device of claim 29, wherein the processor is further configured to determine whether the estimated remaining lifetime of the EMS device is below a threshold.

34. The device of claim 33, wherein the processor is further configured to assign a quality level to the device in response to the determination of whether the estimated remaining lifetime of the EMS device is below a threshold.

35. The device of claim 33, wherein the processor is further configured to identify the device as defective in response to a determination that the estimated remaining lifetime is below the threshold.

36. The device of claim 29, wherein the processor is further configured to select an application for the device based at least in part on the estimated remaining lifetime of the device.

37. The device of claim 29, wherein the processor is further configured to screen the device for failure due to stiction based at least in part on the estimated remaining lifetime of the device.
